(19) United States
(12) Patent Application Publication
(10) Pub. No.: US 2010/0128229 A1
(43) Pub. Date: May 27, 2010

(54) Weather-tight Video Projector with Unattended Operation

(76) Inventor: Richard DeJesus Laboris, Miami, FL (US)

Correspondence Address: Richard D. Laboris, 16062 SW 138 Terrace, Miami, FL, 33196, US

(21) Appl. No.: 12/625,757

(22) Filed: Nov. 25, 2009

Related U.S. Application Data
(60) Provisional application No. 61/117,601, filed on Nov. 25, 2008.

(51) Int. Cl. G03B 21/16

(52) U.S. Cl. 353/52; 353/119

(57) ABSTRACT

An image projector comprises: a LED light source module, a PCB module, a heat sink module, condensing and projecting lenses, and a housing. The printed circuit board (PCB) module further comprises: internal memory for storing video images to be displayed, at least one I/O interface for connection to a host computer for transferring images by either wired or wireless means, a control unit for transferring, storing, and processing images stored in its memory, firmware allowing for unattended operation by automatically looping through stored content, an electronic image forming device for displaying stored images to be projected. The heat sink module is of the natural convection type and is mounted such that ambient air can flow freely around its heat dissipating fins thereby eliminating the need for a fan. The housing encloses all components such that it is suitable for outdoor use.

### CROSS-REFERENCE TO RELATED APPLICATIONS

This application is a continuation of Provisional Patent Application 61/117,601 filed Nov. 25, 2008.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to an image projector; in particular, a weather-tight video projector capable of unattended operation in inclement weather.

Image projectors, by their nature, require high intensity light sources which generate high levels of thermal radiation. Conventional image projectors require vented enclosures and electric ventilation fans in order to keep internal temperatures from rising to unacceptable levels, thus making them unsuitable for outdoor use in inclement weather. Furthermore, conventional image projectors require operator input to display content by either interacting with a connected personal computer or video source or directly interacting with control buttons and/or menu selections on the projector itself.
Relevant prior art includes:
U.S. Pat. No. 7,357,520 April, 2008 Vitantonio et al.
U.S. Pat. No. 7,296,898 November, 2007 Wu
U.S. Pat. No. 6,712,476 March, 2004 Ito et al.

### BRIEF SUMMARY OF THE INVENTION

The primary object of the present invention is to provide a weather-tight video projector that can be used outdoors in inclement weather. Another object of the invention is to provide a video projector that operates unattended without user interaction or connection to an external image source. Other advantages will become apparent from a consideration of the drawings and ensuing description of this application.

### Advantages:

One advantage of the invention is that it may be used outdoors in inclement weather.

Another advantage of the invention is that it operates unattended without user interaction or connection to an external image source.

Another advantage of the invention is that one or several video images may be pre-loaded for continuous projection without intervention.

Another advantage of the invention is that the projection lens assembly can be easily interchanged to modify the throw distance/magnification.

### BRIEF DESCRIPTION OF THE SEVERAL VIEWS OF THE DRAWING

Drawings—Figures:

FIG. 1 shows exemplary uses of the invention.

FIG. 2 is a perspective view of an exemplary embodiment of the invention.

FIG. 3 is a block diagram showing the unattended operation provided by the projector's custom firmware.

### DRAWINGS—REFERENCE NUMERALS

4. Large Heat Sink
5. High Power Light Emitting Diode (LED)/LEDs
6. Current Limiting Resistor
7. Weather-tight DC Power Socket
8. Reflector/Collimating Optic
9. LCD Controller/Video Player Module with on-board Memory/USB Interface
10. Weather-tight USB Socket
11. Transmissive, Color Liquid Crystal Display (LCD) Panel
12. LCD/Lens Mount
13. Condensing Lens
14. Projection Lens
15. Threaded, Interchangeable Lens Mount
16. Weather-Tight Case
17. Mounting/Tripod Socket
18. LCD Ribbon Cable
19. Weather-tight Audio Output Socket
20. Clear Insulating Lens

### DETAILED DESCRIPTION OF THE INVENTION

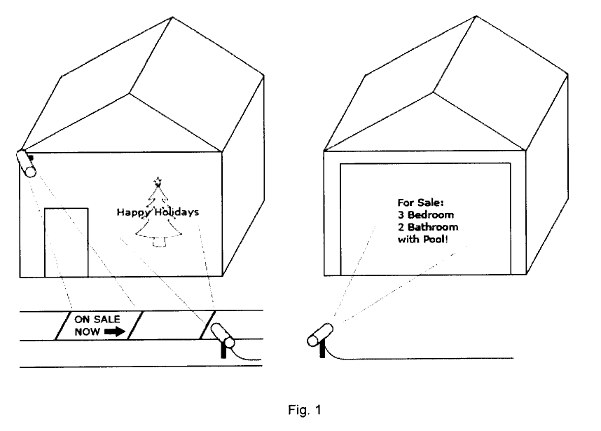

FIG. 1 shows exemplary uses of this invention not suitable for existing video projectors including, but not limited to:
Projecting repeating holiday themed video images onto exterior surfaces of homes or businesses for extended periods of time, through varying weather conditions.
Projecting repeating video images of advertising or public information onto exterior surfaces of buildings and public areas such as walls and sidewalks for extended periods of time, through varying weather conditions.
Projecting repeating real estate marketing information for potential buyers onto an exterior surface of a house or building for extended periods of time, through varying weather conditions.

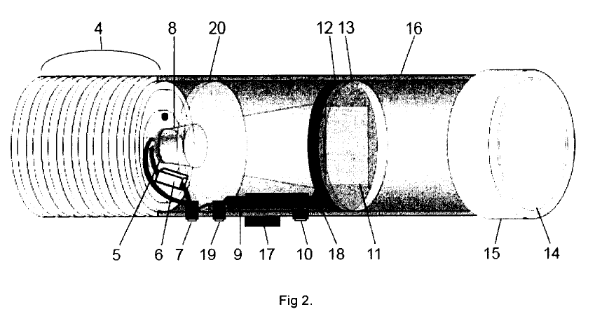

FIG. 2 shows the video projector with a weather-tight case 16 cut away to show internal components. A high power LED or multiple high power LEDs 5 are mounted to a large heat sink 4 using thermally conducting method. The large surface area of the heat sink 4 as well as its placement with fins in contact with the outside air eliminates the need for a cooling fan and/or air vents. A constant current is fed to the LED/LEDs 5 via a current limiting resistor 6 from a weather-tight DC power socket 7. The power socket 7 also feeds power to an LCD controller/video player module 9 which includes on-board memory and USB connectivity. The LCD controller/video player module hardware utilized in the present invention to transfer, store, process and display video images onto the LCD are known in the art (as used in common personal media players “PMPs”) and will not be discussed herein. The LCD controller/video player module 9 is also connected to a weather-tight USB socket 10 for transferring video files from a host computer. The LCD controller/video player module 9 may be further connected to a weather-tight audio output socket 19 for connecting external loud speakers. The LCD controller/video player module 9 is further connected to a transmissive, color liquid crystal display (LCD) panel 11 via a flat ribbon cable 18. A reflector/collimating optic 8 is mounted so that light output from the LED/LEDs 5 is concentrated on the LCD panel 11. The LCD panel 11 is secured by an LCD/lens mount 12. A condensing lens 13 is mounted adjacent to the LCD panel 11 thereby condensing its transmitted light towards a projection lens 14. Spherical lenses of the piano-convex or biconvex type, which are common and inexpensive, work well as both condensing and projection lenses. To minimize image distortion due to aberrations, more expensive aspheric lenses and/or compound lens sets may be used. The projection lens 14 is mounted to a threaded, interchangeable lens mount 15 which is attached to the case 16 via corresponding threads of the opposite gender. Although FIG. 2 shows the lens mount 15 having female threads (accepting the male threads of the case 16), the arrangement may be inverse—lens mount 15 having male threads being accepted by corresponding female threads on case 16. Manual focus is accomplished by rotating lens mount 15 causing it to move axially towards or away from condensing lens 13. Lens mount 15 and corresponding lens 14 can be easily interchanged with others of varying tubular length and focal length to allow for varying throw distance/magnification. A clear insulating lens 20 may be included to insulate the LCD controller/video player module 9 and LCD panel 11 from excessive heat generated by high-power LED/LEDs 5.

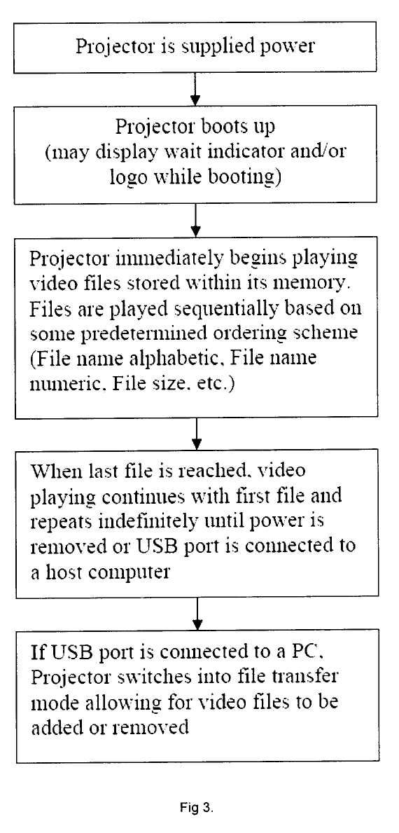

FIG. 3 is a block diagram showing the unattended operation provided by the projector's custom firmware.

### Alternative Embodiments

A constant current producing circuit may be used instead of the current limiting resistor 6 to improve power efficiency.

A wired or wireless communications module using standard technologies such as (but not limited to) Ethernet, 802.11, Bluetooth or cellular may be included to allow for adding or removing video files via networked or wireless connection to a host computer.

An internal loud speaker may be included instead of or in addition to the audio output socket.

The invention claimed is:

1. An image projector comprising:
a light source module for producing the light needed for the projection of the image, the light source module comprising:
a light emitting diode (LED) or cluster of light emitting diodes;
a reflector or collimating optic to concentrate the light onto the image forming device;
a LED driver circuit or current limiting resistor;
a printed circuit board (PCB) module to transfer, store, process and display the image to be projected, the PCB module comprising:
an internal memory for storing images to be displayed;
at least one I/O interface for connection to a host computer for transferring images by either wired or wireless means;
a control unit for transferring, storing, and processing images stored in its internal memory;
a firmware program allowing for unattended operation by automatically looping through stored images in some predetermined order; and
an electronic image forming device for displaying stored images to be projected;
a heat sink module for dissipating the heat generated by the light source module, the heat sink module being of natural convection type of sufficient surface area and mounted such that ambient air can flow easily around its heat dissipating fins, thereby eliminating the need for a fan;
a condensing lens to condense light output the image forming device onto the projection lens;
a projection lens module to focus the image output the condensing lens onto the projection surface, the projection lens module comprising:
a projection lens;
a threaded projection lens frame which moves axially towards or away from the condensing lens as it is rotated;
a weather-tight enclosure to contain all components while positioning the heat sink module in direct contact with outside air flow.

2. The image projector according to claim 1, wherein the projection lens module can be easily interchanged to modify the throw distance of the projected image; [symbol]
